(19) United States
(12) Patent Application Publication
(10) Pub. No.: US 2009/0055219 A1
(43) Pub. Date: Feb. 26, 2009

(54) APPARATUS TO MEASURE MEDICAL DATA AND TO REGISTER THE IDENTITY OF A PATIENT

(76) Inventor: Peter Schaub, Munich (DE)

Correspondence Address: SCHIFF HARDIN, LLP;PATENT DEPARTMENT, 6600 SEARS TOWER, CHICAGO, IL, 60606-6473, US

(21) Appl. No.: 12/193,256

(22) Filed: Aug. 18, 2008

(30) Foreign Application Priority Data
Aug. 21, 2007 (DE) 10-2007-039 448.0

(51) Int. Cl. G06Q 50/00

(52) U.S. Cl. 705/2

(57) ABSTRACT

An apparatus for measurement of medical data of a patient is used to automatically update the patient file, has a device to measure such medical data at an examined patient, a device to register data that enable determinations of the identity of the examined patient, and a device to link a patient identity with measured medical data.

### BACKGROUND OF THE INVENTION

1. Field of the Invention

The present invention is concerned with an apparatus to measure medical data and to register the identity of a patient.

2. Description of the Prior Art

In the examination of patients in hospitals or other medical facilities, the problems of the measurement of medical data for a large number of patients and the correct linking of the measured medical data with the identity of the examined patient are confronted. Known solutions for this purpose require manual linking of the patient identity with the measured medical data by the examining hospital personnel. This normally means that the measured medical data of an examined patient are manually entered together with his or her identity into a list, table or file.

In other cases, the list, table or file is already associated with a single patient identity, for example in that the patient identity is recorded once (for example in the header of the document) or in that the file name is derived from the patient identity. However, in these cases the personnel must also ensure that the measured medical data are correctly associated with the identity of the actual examined patient. These processes are often time-consuming and sometimes error-prone.

### SUMMARY OF THE INVENTION

An object of the present invention is to improve this situation.

The above object is achieved in accordance with the present invention in a method and an apparatus wherein medical data are measured from an examined patient, and data are registered that enable a determination of the examined patient, and the identify of the examined patient is then linked with the measured medical data obtained from the examined patient.

### BRIEF DESCRIPTION OF THE DRAWINGS

FIG. 1 schematically illustrates an embodiment of the apparatus according to the invention, and illustrated simultaneously is the basic workflow of an embodiment the method according to the invention.

FIG. 2 shows a second embodiment of the present invention.

FIG. 3 shows a third embodiment of the present invention.

### DESCRIPTION OF THE PREFERRED EMBODIMENTS

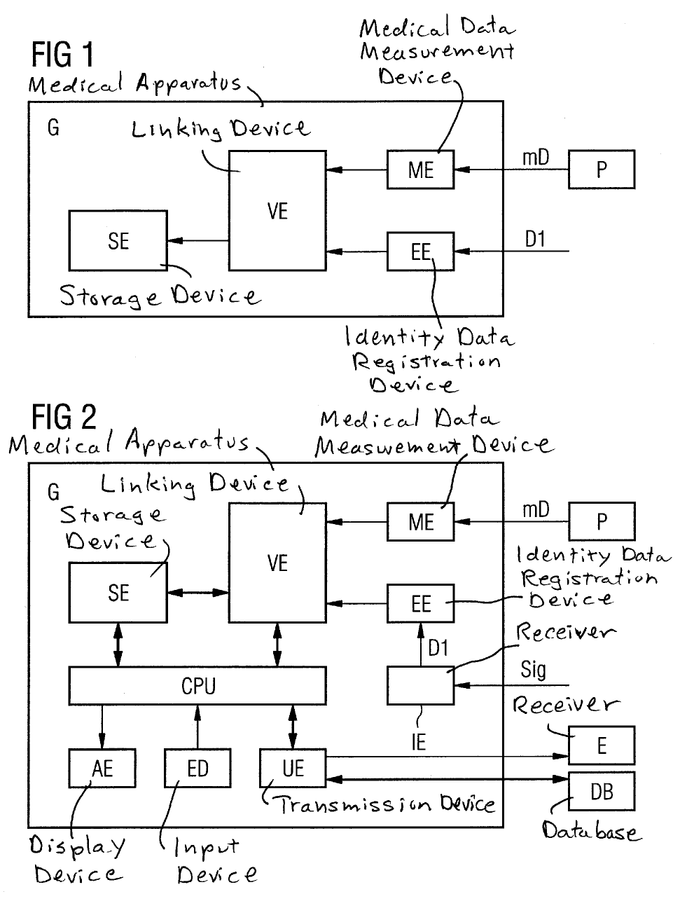

As is schematically shown in FIG. 1, the medical apparatus G for measurement of medical data mD of a patient includes a device ME to measure such medical data at an examined patient and a device EE to register data D1 that enable determinations of the identity of the examined patient P. The apparatus G also has a device VE to link a patient identity with measured medical data.

The device ME to measure medical data mD can be, for example, a blood pressure measurement apparatus or a blood sugar measurement apparatus, or a similar apparatus to measure medical data, or a combination of such apparatuses. The measured medical data mD are correspondingly blood pressure values or blood sugar values of the examined patient, for example.

The measured medical data mD of the patient P are relayed to the device for linking VE after their measurement by the measurement device ME. The acquired data D1 that enable determinations of the identity of the examined patient are also relayed to this device VE. The measured medical data mD of the patient to be examined are thereupon linked with the registered data D1 by the linking device VE. Finally, in a preferred embodiment of the invention the linked data (D1, mD) are stored in a storage device SE of the medical apparatus G.

As an alternative to this embodiment variant of the local storage of the linked data, or in combination with this embodiment, in a further embodiment of the invention, the transmission of the medical data (D1, mD) linked with a patient identity ensues via a transmission device UE to a receiver E located outside of the apparatus G. This depends on the integration of the apparatus G according to the invention into infrastructure of the hospital or another medical facility (simply called a “hospital” in the following), whether the local storage of the linked data in the apparatus G is sufficient or advantageous, or whether an alternative or additional transmission of the linked data to an external receiver is more advantageous.

Even if the transmission of the linked data with the aid of the transmission device at the moment of the data acquisition is foregone, a later transmission of the data which is first stored locally to an external receiver E can ensue, which external receiver E is normally a central device of the hospital or one of a number of receivers that are connected with such a central device of the hospital. In general, it is advantageous to store the linked data at least temporarily in a local storage device SE of the apparatus G.

FIG. 2 shows an additional possible embodiment variant of the invention in which the apparatus G is additionally equipped with a display device AE. This display device should serve to display a patient identity or a list of patient identities. The apparatus G in this embodiment is also equipped with an input device ED with whose help a confirmation, rejection, selection or modification of displayed patient identities or also only a portion of these measures is possible, for example. This embodiment of the invention is particularly advantageous when a clear determination of the patient identity is not possible using the registered data D1.

In these cases, a list of possible patient identities (for example of patient names) which are consistent with the registered data D1 is advantageously displayed to the personnel who implement the examination. The examining person can select and confirm the applicable patient identity from this list. In some cases, the displayed patient identity can also be inapplicable or the list of the displayed patient identities can possibly contain no matching identity. In these cases, the examining person can make a change to the displayed patient identity or identities and confirm this after the change.

In each case, via this or a combination of such measures it is ensured that the acquired medical data are linked with the matching patient identity and are stored in the system (locally in the memory SE of the apparatus and/or in a storage unit located outside of the apparatus via the receiver E).

In the embodiment of the invention schematically shown in FIG. 2, a central processing unit CPU is provided to process all or some occurring data in an exemplary manner. This example illustrates only one possibility for realization that in many cases will be advantageous, but which is not indispensable to the realization of the invention.

In general, the realization of the invention with the use of a processor (CPU) or possibly multiple processors on which software modules run will be advantageous, which software modules realize the individual or a few function units (for example the linking device VE and/or the registering device EE or the measurement device ME) partially or entirely by program code. Using the explanations present here, it poses no difficulties to those skilled in the art to realize the invention with the use of commercially available processors and corresponding software in connection with additional commercially available hardware such as, for example, storage devices, communication interfaces, etc. The development of the software required for this also poses no problems to the man skilled in the art after reading the present explanations.

In an additional embodiment of the invention that is likewise shown in FIG. 2, the apparatus also has a receiver IE to receive data, wherein this receiver IE receives signals Sig when the apparatus G approaches the examined patient and converts these signals into first data D1 that, alone or together with second data D2, enable determinations of the identity of the examined patient. These second data D2 are stored in a database DB.

In the example shown in FIG. 2, this database DB is arranged outside of the apparatus and the data transfer occurs via the aforementioned device UE for transmission of data, for example. However, this is not the only possibility to store the second data D2. It is likewise possible for the apparatus G to have a local database DB in which the second data D2 are locally stored. This local storage of the second data D2 is appropriate when the hospital or the facility in which the examinations are implemented has no central data storage (retention). Otherwise, an embodiment of the invention in which the database DB is located outside of the apparatus so that a central data storage of the facility (hospital) is possible may sometimes be more advantageous.

The transmission device shown in FIG. 2 is consequently required to transmit the data D2 between the database DB and the apparatus G only in the cases in which the database is housed outside of the apparatus. Those skilled in the art will realize that different (dedicated) transfer devices can naturally also be used for the communication with the receiver E or with the database DB instead of a single transmission device UE.

In most cases it is advantageous to use wireless transfer devices for this. Where this is not desired or is connected with disadvantages, wired transmission methods or the exchange of portable storage media for data transfer can naturally also be used.

The conversion of the received signals Sig into the first data D1 will in many cases comprise a demodulation and an analog-digital conversion, thus generally known steps for conversion of electromagnetic or optical signals into corresponding states of digital circuits.

In an advantageous embodiment of the present invention, the device EE to register data receives (via the receiver IE) signals with which the geographic position of the apparatus G can be determined. For example, such signals can originate from the GPS system available worldwide or from similar systems. Namely, the geographic position of the apparatus at the point in time of the measurement can easily be used to derive determinations of the identity of the examined patient, for example under the assumptions that the apparatus G is near the examined patient at the point in time of the measurement and that the patient, at the point in time of the measurement, is located at a location that allows determinations of the identity of the patient. A simple example of this is a situation in which a measurement ensues at the hospital room of the patient. By means of an entry in the database DB designating the room in which the patient is staying, the patient identity can be derived (or at least assumed) from the determination of the geographic position of the apparatus at the point in time of the detection if the patient identity.

This determination is not yet unique given a population of a room with multiple patients, such that in these cases a list in which multiple patients are available for selection is advantageously displayed to the examining personnel, for example. As illustrated further above, the examining personnel will select the actual examined patient from this list.

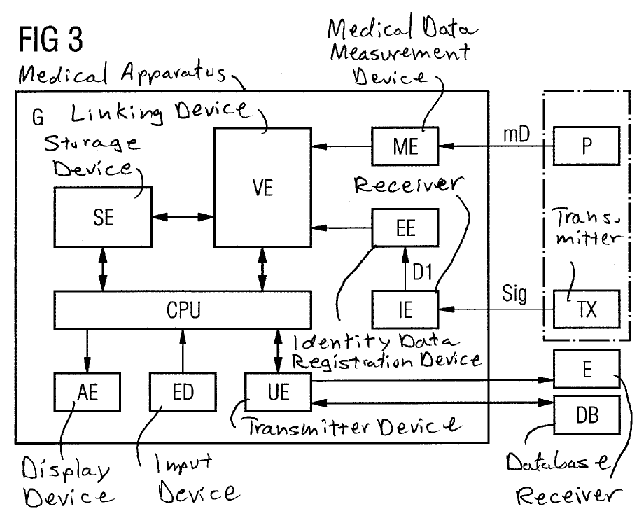

FIG. 3 shows in a schematic manner an additional embodiment variant of the invention in which the apparatus receives signals from a transmitter (TX) that is installed in a room of the examined patient or a fixture located in said room. Such a transmitter (TX) could, for example, be what is known as an RFID chip that emits the patient identity when it is supplied with energy. Such an energy supply could, for example, also emanate from the measuring apparatus G. It is particularly advantageous when the transmitter TX is connected in a fixed manner with the patient, thus for example is directly attached to the patient, for example in the form of an arm band with corresponding RFID chip. Such an arm band can be easily handed out to the patient upon his or her admission to the hospital.

Additional information about RFID chips and their applications is located in the “RFID-Handbuch” by Klaus Finkenzeller, 2nd edition, Hanser-Verlag, Munich, 2000, ISBN 3-446-21278-7. The entire content of this book is herewith expressly made a component of the present patent application.

Particularly advantageous RFID systems that bridge more than 1 m between reader and transponder are suitable for the use intended here. In Europe, these systems normally operate at frequencies between 433 MHz and 5.6 GHz. For this purpose, the receiver IE can be an RFID reader is advantageously integrated into the apparatus (G), in contrast to which the transponder is advantageously integrated into an arm band that is worn by the patient during a hospital stay.

Insofar as an energy supply of the transponder by the reader (IE) (for example via the electromagnetic waves radiated by the reader (IE)) is not considered, the transponder is advantageously equipped with its own power supply in the form of a battery and possesses a power-saving “power-down” or “stand-by” mode. In this mode (operating state), the power consumption of the transponder can easily be limited to a few microamps. If the transponder leaves the field of a reader, it automatically switches into the power-saving mode. The transponder is active again and resumes its normal operation again only by receiving a sufficiently strong signal of a reader.

Using the explanations present herein, those skilled in the art will recognize that there are many possibilities to realize the present invention. It is primarily important that the data D1 or the signals Sig from which they are derived allow optimally unambiguous determinations of the identity of the examined patient. Whether GPS signals or signals emanating from an RFID chip in an armband of the patient are more advantageous for this depends on the circumstances of the individual case.

In the event that GPS signals or the like are signals suitable for geographic position determination, additional data D2 are regularly necessary to refer to the patient identity, with the aid of which data D2 the patient identity can be determined. A GPS signal itself contains no indication of a patient identity. However, if the geographic coordinates of the hospital room of this hospital and the occupancy of the room with individual patients (using the patient identity) are stored, for example in a database DB of the hospital, first data D1 (in this case the coordinates of the apparatus G at the point in time of the measurement of the medical data mD of the examined patient P) can be acquired from the GPS signals in a known manner. The hospital room in which the measurement occurs can initially be determined via a comparison of the acquired data D1 with the room coordinates stored in the database DB. The identity of the examined patient or a list of patients in this room can then be derived from the occupancy of the room with patients (which are assumed to be known).

If the precision of the signals Sig should not suffice for unique determination of the room of the examination, the list could also contain the names of the patients of multiple rooms. However, if the signals are so precise that a differentiation between individual beds (or parts) of a room is possible, individual patients can possibly already be determined even given a multiple occupancy of the room.

In practice, such a determination of the identity of the respective examined patient will possibly not always run entirely without errors. However, as long as these errors occur sufficiently rarely and the personnel can easily recognize the errors and can correct them via changes, a usable productivity gain might be achievable. For example, if the signals Sig originate from an RFID in an arm band of the examined patient or from another transmitter TX attached to his body (FIG. 3), such mix-ups will occur rather rarely, and actually only when another patient is located in the immediate proximity of the examined patient at the point in time of the examination. Moreover, in these cases the signals Sig can be individual to each patient, whereby the possibility exists that the first data D1 are already the patient identity, thus for example a unique patient number from which the name of the patient and possibly other information about the patient can be derived (for example with the aid of a database of the hospital).

With the use of the present invention, it is possible in a simple manner to keep a (for example electronic) patient file current. The following exemplary scenario shows this: the personnel (for example a nurse) measure the blood pressure of a patient, for example. Now the measured value should be input into the data processing system of the hospital. In order to avoid errors as much as possible, the blood pressure measurement apparatus interacts with a GPS receiver. For example, if this blood pressure measurement apparatus is activated, the GPS coordinates are transmitted (for example via W-LAN) to the hospital system. Using the GPS coordinates, which isolate a region of under one meter, this hospital system can determine the room, the hospital bed and thus the name of the patient and return these to the blood pressure measurement apparatus.

The blood pressure measurement apparatus displays the name of the patient, the nurse confirms this and the measurement can ensue.

The measurement results are transferred directly to the system of the hospital. Transmission errors are hereby precluded in practice. In the event that the room has multiple occupants, for safety multiple names are transferred (for example in geographic order). In the event that the examined patient lies in a changed bed, a nurse can select a different (the correct) patient from the specifications.

Although modifications and changes may be suggested by those skilled in the art, it is the intention of the inventor to embody within the patent warranted hereon all changes and modifications as reasonably and properly come within the scope of his contribution to the art.

I claim as my invention:

1. A medical apparatus comprising:
a medical data measurement device configured to measure medical data from an examined patient;
an identity data registration device configured to register data that determine the identity of the examined patient; and
a linking device configured to automatically link said data that determine the identity of the examined patient with said measured medical data.

2. An apparatus as claimed in claim 1 comprising a storage device configured to store the measured medical data linked with the data that determine the identity of the examined patient.

3. An apparatus as claimed in claim 1 comprising a transmission device configured to transmit the measured medical data linked with the data that determine the identity of the examined patient to a receiver remote from said transmission device.

4. An apparatus as claimed in claim 1 comprising a display device connected to said linking device that displays information representing the identity of the examined patient, and in input device in communication with said display device that allows manual confirmation, rejection, selection or modification of at least a portion of the information displayed at said display device.

5. An apparatus as claimed in claim 1 wherein said identity data registration device comprises a receiver that has a receiver field that interacts with the examined patient when the examination patent is in the receiver field, to receive signals from the examined patient and that converts said signals into first data, and wherein said identity data registration device further comprises a database in which second data are stored, said second data, in combination with said first data, enabling determination of the identity of the examined patient.

6. An apparatus as claimed in claim 5 wherein said database is located remote from said medical data measurement device, said receiver of said linking device, and said linking device, and wherein said identity data registration device comprises a transmission device placing said identity data registration device in communication with said database allowing exchange of data between said identity data registration device and said database.

7. An apparatus as claimed in claim 5 wherein said second data comprise a designation of a physical location of the examined patient, and wherein said identity data registration device comprises a geographic position detector that detects a geographic position of the receiver, and wherein said linking device links said measured medical data with the identity of the examined patient by matching the designation of the location of the examined patient with the geographic location of the identity data registration device.

8. An apparatus as claimed in claim 1 wherein said identity data registration device comprises a transmitter configured to be worn on the body of the examined patient that emits signals designating the identity of the examined patient.

9. An apparatus as claimed in claim 1 wherein said identity data registration device comprises a transmitter in a room in which the examined patient is located, said transmitter emitting a signal designating the identity of the examined patient in the room.

10. An apparatus as claimed in claim 1 comprising a display device in communication with said linking device that displays a list of patients, and that also displays a prompt to select the name of one of the patients as a confirmation of linking of said measured medical data with the identity of the examined patient, and comprising an input unit in communication with said display device allowing manual entry of said confirmation.

11. A method comprising the steps of:
non-manually measuring medical data from an examined patient;
non-manually registering data that determine the identity of the examined patient; and
non-manually linking said data that determine the identity of the examined patient with said measured medical data.

12. A method as claimed in claim 11 comprising electronically storing the measured medical data linked with the data that determine the identity of the examined patient.

13. A method as claimed in claim 11 comprising transmitting the measured medical data linked with the data that determine the identity of the examined patient to a location remote from said examined patient.

14. A method as claimed in claim 11 comprising displaying information representing the identity of the examined patient and allowing manual confirmation, rejection, selection or modification of at least a portion of the displayed information.

15. A method as claimed in claim 11 comprising registering said data that determine the identity of the examining patient using a receiver that has a receiver field that interacts with the examined patient when the examination patent is in the receiver field, to receive signals from the examined patient and converting said signals into first data, and comprising storing second data in a database and using said second data, in combination with said first data, to determine the identity of the examined patient.

16. A method as claimed in claim 15 comprising locating said database remote from said examined patient exchanging data between said receiver and said database.

17. A method as claimed in claim 15 wherein said second data comprise a designation of a physical location of the examined patient, and comprising detecting a geographic position of the receiver, and linking said measured medical data with the data that determine the identity of the examined patient by matching the designation of the location of the examined patient with a geographic location of the receiver.

18. A method as claimed in claim 11 comprising registering said data that determine the identity of the examined patient using a transmitter configured to be worn on the body of the examined patient that emits signals designating the identity of the examined patient.

19. A method as claimed in claim 11 comprising registering said data that determine the identity of the examined patient using a transmitter in a room in which the examined patient is located, said transmitter emitting a signal designating the identity of the examined patient in the room.

20. A method as claimed in claim 11 comprising displaying a list of patients, and a prompt to select the name of one of the patients as a confirmation of linking of said measured medical data with the identity of the examined patient, and allowing manual entry of said confirmation.
